(19) United States
(12) Patent Application Publication
(10) Pub. No.: US 2006/0079216 A1
(43) Pub. Date: Apr. 13, 2006

(54) System for detecting the production data of a number of textile machines

(76) Inventor: Francisco Speich, Gipf-Oberfrick (CH)

Correspondence Address: George Pappas, Suite 300, 919 S. Harrison Street, Fort Wayne, IN, 46802, US

(21) Appl. No.: 10/537,023

(22) PCT Filed: Dec. 3, 2003
(86) PCT No.: PCT/CH03/00799

§ 371 Date: Jun. 1, 2005

(30) Foreign Application Priority Data
Dec. 11, 2002 (CH) 2120/02

(51) Int. Cl. H04M 3/00

(52) U.S. Cl. 455/418

(57) ABSTRACT

The invention relates to a system comprising control computers (1) for controlling and detecting the operating data e.g. the speed, stoppage, cause of stoppage, etc., for each textile machine, and a central computer (2) for determining the production data. The control computers (1) and the central computer (2) respectively comprise means (3) for wireless signal transmission, and form, with a respectively associated transmission unit (4, 5), a radio network for signal transmission according to the WLAN or Bluetooth standard. The transmission units (4, 5) are connected by a telephone line (6), such that the control computers (1) and the central computer (2) can be positioned at any distance in relation to each other. In this way, the means required for the network are significantly reduced, the production data is determined in a centralised manner, and a centralised production control is achieved.

### TECHNICAL FIELD

The invention relates to a system for determining production data of and controlling a number of weaving or knitting machines, according to the preamble of claim 1.

### PRIOR ART

DE 100 55 025 A discloses a system for controlling a number of spinning preparation machines by means of a central computer. The system consists essentially of control computers for controlling the spinning preparation machines and for acquiring the operating data of each spinning preparation machine, a server and a central computer. The control computers are connected via a cable network to the central computer. The cable network contains a server and a modem, which are respectively assigned to the control computers and to the central computer, and which are connected via a data line.

It is known from EP 1 128 244 A to connect a number of machine tools, in particular injection molding machines, via a network to a central computer, the individual machine tools firstly being connected via a radio link to a common server, which is in turn connected via a wire line to the central computer.

The known spinning preparation machines and machine tools, such as injection molding machines, are machines in which products are produced according to a fixed program and therefore only the production parameters need to be monitored and controlled. These documents, however, do not disclose any indication that the networks are also suitable for the control of weaving or knitting machines which operate according to alternating pattern programs.

Weaving or knitting machines respectively comprise a series of functional groups, for weaving machines these being for example drive, technical configuration, weft thread input and product output. The functional groups are controlled by the control computer according to a weaving program. The weaving program comprises the operating data for the article to be weaved, for example the pattern data. The weaving program is loaded in situ into the control memory. The article then starts to be weaved, with the newly determined operating data being continuously acquired by the control computer. Once the weaving has finished, the operating data are stored in the control computer, for example by an acknowledgement signal. The operating data could be stored in situ on a data medium.

In textile factories, there are a large number of different weaving or knitting machines. Each weaving or knitting machine contains various functional groups, which can respectively be controlled by a system as described above.

Such a system has the disadvantages that a correspondingly complex cable network is required according to the number of weaving or knitting machines and functional groups per weaving or knitting machine, different cable networks are required for various types of weaving or knitting machines, and the outlay and costs for these networks are high so that the distance between the weaving or knitting machine and the central computer is limited.

### SUMMARY OF THE INVENTION

It is an object of the invention to provide an improved system for determining the production data of and controlling a number of weaving or knitting machines.

This object is achieved by independent claim 1. The dependent claims relate to refinements.

It has surprisingly been found that a number of weaving or knitting machines operating according to alternating pattern programs can also be controlled straightforwardly by a central computer, and the production data can be acquired, when the control computers assigned to each weaving or knitting machine are respectively connected via wireless signal transmission means to at least a first transmission unit, the latter being at least partially connected by means of a data line to the central computer. The first transmission unit may be connected by means of a data line, preferably a telephone line, directly to the central computer or to a second transmission unit, in which case the latter may in turn be connected via wireless transmission means to the central computer.

It is preferable for the wireless transmission means to form a radio network for transmission according to the WLAN or Bluetooth standard. These radio networks allow bidirectional transmission so that, besides determining the production data, it is also possible to communicate operating data and pattern data to the control computers of the weaving or knitting machines.

It is preferable for the wireless transmission means to be a send and receive unit, these being integrated into the associated devices, such as the control computers, transmission units and the central computer. The operating data of different types of weaving or knitting machines can thereby be acquired with the same system.

A unit for expanding the radio cell may be assigned to the radio network for the control computers and to the first transmission unit. The advantage of this is that the radio network can be adapted to the number of weaving or knitting machines.

By connecting the transmission units via a data line, for example a telephone line, the central computer can be located away from the place where the weaving or knitting machines are set up.

The central computer is preferably a CAM computer, to which a printer is assigned. This offers the opportunity to determine the production data of the textile factory from the operating data. The production data may also be forwarded for the purpose of production management.

The system may be assigned a mobile computer such as a laptop, mobile phone or tablet PC. With such a mobile computer, it is possible to access the control computer and the central computer within the local radio traffic network. The opportunity for access is extended if there is a remote radio traffic network.

The weaving or knitting machines to be simultaneously monitored may be of different types, but they are preferably of the same type.

### BRIEF DESCRIPTION OF THE DRAWINGS

The invention will be explained below with reference to the appended drawings, in which:

FIG. 1 shows a block diagram of an embodiment of the system, and

FIG. 2 shows a modification of the embodiment of the system according to FIG. 1.

### EMBODIMENTS OF THE INVENTION

The system will be described below in the application for weaving machines, which have a control computer 1.1 to 1.n.

The system consists essentially of a central computer 2, a number of send and receive units 3 which are integrated into the control computers 1.1 to 1.n and into the central computer 2, a first transmission unit 4 which is assigned to the control computers, and a second transmission unit 5 which is assigned to the central computer 2. With the respectively assigned transmission unit, the send and receive units 3 form a radio network or a radio cell for signal transmission according to the WLAN or Bluetooth standard. The transmission units 4, 5 respectively have a send and receive unit 3 and a modulator/demodulator unit and they are connected to one another via a data line, preferably a telephone line 6. It is thus possible to wirelessly connect a group of weaving machines, for example inside a machine room, to a transmission unit which can in turn communicate to a central computer at any distance away. All the weaving machines within a machine room may be connected to a transmission unit, or individual groups of weaving machines may respectively be connected wirelessly to an associated transmission unit.

A unit 9 for expanding the radio network or the radio cell, which is provided on the transmission unit 4, may be assigned to the radio network for the control computers 1.1 to 1.n and the first transmission unit 4.

The central computer 2 is a CAM computer. Most importantly, the CAM computer acquires the operating data. Provision is furthermore made to communicate a stop signal and a start signal to the control computer 1.1 to 1.n. A printer 11 for recording the operating data and a scanner 10 are assigned to the CAM computer. An image to be replicated in the product web to be produced is digitized by the scanner 10 and stored as pattern data in the CAM computer. The. CAM computer communicates the pattern data to the control computer 1 of the respective weaving machine. In the central computer or in the control computer, the digitized pattern data are converted into machine data processable by the weaving machine.

The system is assigned a mobile computer 7 such as a laptop, mobile phone or tablet PC, using which the data of the control computers 1.1 to 1.n and/or of the central computer 2 can be queried and a stop signal can be sent to the control computers.

The operating data acquired may, for example, be the speed of the weaving machine, the run time of the weaving machine, inactivity of the weaving machine, the cause of the inactivity, the inactivity time, the weft number, the number of weaved patterns, etc. The status of the weaving machine as well as the production data of the goods produced are determined from these operating data. These include, for example, the articles produced and the quantity of produced articles. The operating data and/or the production data are employed for the production management.

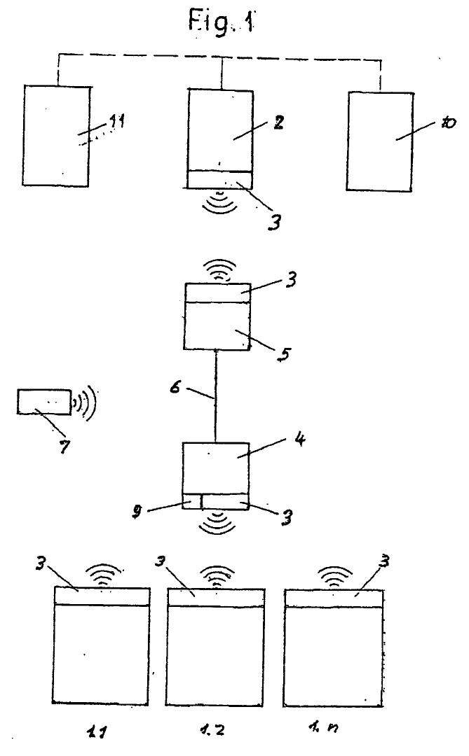

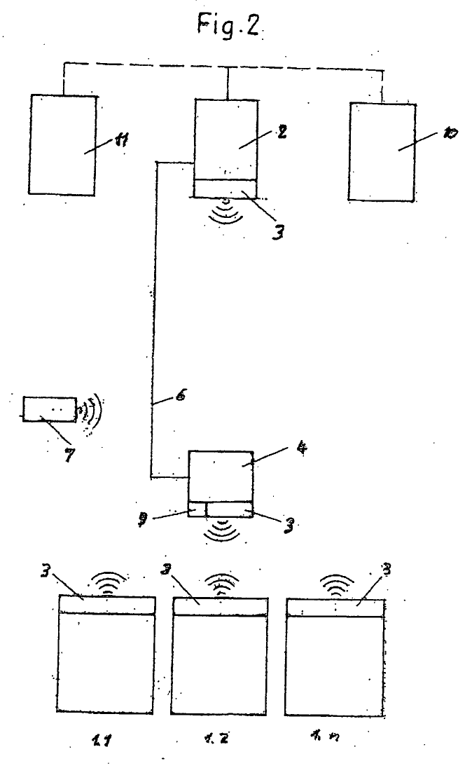

The embodiment according to FIG. 2 differs from the embodiment according to FIG. 1 merely in that the first transmission unit 4 is connected directly to the central computer 2 via the data line 6.

The system of FIGS. 1 and 2 comprises control computers 1.1 to 1.n for controlling the weaving machine and for acquiring operating data, for example speed, inactivity, cause of the inactivity, etc. for each weaving machine, and a central computer 2 for determining the production data. The control computers 1.1 to 1.n and the central computer 2 respectively have wireless transmission means 3, and with a respectively assigned transmission unit 4, 5 they form a radio network for signal transmission according to the WLAN or Bluetooth standard. The transmission units 4, 5 are connected via a telephone line 6, so that the control computers and the central computer can be set up at any distance from one another. This substantially reduces the outlay for the network, and facilitates central determination of the production data as well as central production management. The production data required in a weaving machine so as to produce the goods may be generated in the control computer, or entered into the control computer by means of data media or from the central computer.

1. A system for determining the production data of and controlling a number of weaving or knitting machines, containing a control computer for each weaving or knitting machine and a central computer, which are networked, characterized in that the control computers are respectively connected via wireless signal transmission means to at least a first transmission unit, the latter being at least partially connected to the central computer by means of a data line.

2. The system as claimed in claim 1, characterized in that the central computer is connected via wireless signal transmission means to a second transmission unit.

3. The system as claimed in claim 1, characterized in that the wireless signal transmission means form a radio network for signal transmission according to the WLAN or Bluetooth standard.

4. The system as claimed in claim 1, characterized in that the wireless transmission means have a send and receive unit, these being integrated into the respective terminal device.

5. The system as claimed in claim 1, characterized in that a unit for expanding the radio cell is assigned at least to the radio network for the control computers and to the first transmission unit (4).

6. The system as claimed in claim 1, characterized in that the data line is a telephone line.

7. The system as claimed in claim 1, characterized in that the first and second transmission unit are connected via a data line, preferably a telephone line.

8. The system as claimed in claim 1, characterized in that the central computer is a CAM computer for determining the production data from the operating data and for storing pattern data.

9. The system as claimed in claim 1, characterized in that a printer for recording the operating data is assigned to the central computer.

10. The system as claimed in claim 1, characterized in that a scanner for digitizing image data is assigned to the central computer.

11. The system as claimed in claim 1, characterized by a mobile computer such as a laptop, mobile phone or tablet PC for querying the data of the control computers and/or of the central computer.

12. The system as claimed in claim 1, characterized in that digitized data can be converted in the central computer or in the control computer into machine data processable by the weaving or knitting machine.

13. The system as claimed in claim 2, characterized in that a unit for expanding the radio cell is assigned at least to the radio network for the control computers and to the first transmission unit.

14. The system as claimed in claim 2, characterized in that the first and second transmission unit are connected via a data line, preferably a telephone line.
